(19) United States
(12) Patent Application Publication
(10) Pub. No.: US 2022/0120924 A1
(43) Pub. Date: Apr. 21, 2022

(54) FAST NEUTRON SCINTILLATOR SCREENS COMPRISING LAYERS, AND RELATED METHODS AND SYSTEMS

(71) Applicants: Steven L. Cool, Reading, MA (US); Battelle Energy Alliance, LLC, Idaho Falls, ID (US)

(72) Inventors: William C. Chuirazzi, Idaho Falls, ID (US); Aaron Craft, Idaho Falls, ID (US); Steven L. Cool, Reading, MA (US); Burkhard Schillinger, Munchen, DE (US)

(21) Appl. No.: 17/451,610

(22) Filed: Oct. 20, 2021

Related U.S. Application Data
(60) Provisional application No. 63/094,171, filed on Oct. 20, 2020.

(51) Int. Cl. G01T 3/06

(52) U.S. Cl. CPC G01T 3/06

(57) ABSTRACT

A fast neutron scintillator screen includes a converter material and a scintillator material in contact with the converter material. The converter material comprises a hydrogenous material, exhibits a thickness of from about 10 μm to about 1500 μm, and is formulated to produce recoil protons responsive to interactions with neutrons. The scintillator material comprises a phosphor formulated to produce photons responsive to interactions with the recoil protons. A method of conducting neutron radiography is also disclosed, as well as a system comprising the fast neutron scintillator screen.

### CROSS-REFERENCE TO RELATED APPLICATION

This application claims the benefit under 35 U.S.C. § 119(e) of U.S. Provisional Patent Application Ser. No. 63/094,171, filed Oct. 20, 2020, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-051D14517 awarded by the United States Department of Energy. The government has certain rights in the invention.

### TECHNICAL FIELD

The disclosure relates generally to devices, methods, and systems for neutron detection. More specifically, the disclosure relates to fast neutron scintillator screens including layers, as well as methods and systems of utilizing fast neutron scintillator screens for neutron detection, such as in digital neutron imaging.

### BACKGROUND

Increasing demand on law enforcement to detect explosives, weapons, and contraband such as illegal substances or smuggled trade items has led to the development and improvement of non-destructive screening technologies. A multitude of testing and detection methods, such as colorimetry, electrochemistry, ion detection spectroscopy, mass spectroscopy, X-ray spectroscopy, and X-ray imaging, are currently deployed to screen for these items. Neutrons' high penetration power in heavy shielding applications, their indifference to electromagnetic interference, and their ability to distinguish isotopic composition make neutron imaging a unique and useful non-destructive detection tool that can be used to augment existing detection capabilities.

Neutron radiography has been used in a variety of settings, including those of nuclear fuels and cargo scanning, to detect contraband as well as in industrial applications, such as fuel cell and turbine blade analysis. Neutron radiography images the internal condition of a sample by measuring neutron transmission through the sample and is used to provide contrast between certain sample materials in a complementary manner to other imaging techniques, such as X-ray radiography. Neutron radiography provides non-destructive images of a sample's internal structure unlike those produced with ionizing radiation (e.g., X-rays and radioisotopes). However, thermal neutrons and cold neutrons are unable to penetrate large or dense samples. Fast neutrons interact less strongly with materials than thermal neutrons do, which allows fast neutrons to penetrate deeper into samples. The greater degree of penetration of the fast neutrons makes fast neutron imaging a useful tool when examining large, dense, or highly attenuating samples that cannot be penetrated by thermal neutrons or X-rays. While fast neutron imaging is being investigated, conventional fast neutron mixed plastic scintillator technologies have relatively poor spatial resolution, which limits the usefulness of this technique. The fast neutron mixed plastic scintillator screen includes a hydrogenous material and a scintillator material, which are mixed together. The scintillator material is embedded, or inextricably mixed, in the hydrogenous material. To provide sufficient light output, the conventional fast neutron mixed plastic scintillator screen has a thickness of between 1.5 mm and 3.0 mm.

### BRIEF SUMMARY

A fast neutron scintillator screen is disclosed and comprises a converter layer and a scintillator layer. The converter layer comprises a hydrogenous material and exhibits a thickness of from about 10 μm to about 1500 μm. The converter layer is formulated to produce recoil protons responsive to interactions with neutrons. The scintillator layer is in contact with the converter layer and comprises a phosphor formulated to produce photons responsive to interactions with the recoil protons.

A method of conducting neutron radiography is also disclosed and comprises interacting a neutron beam with an object and directing fast neutrons from the neutron beam through a fast neutron scintillator screen to produce photons. The fast neutron scintillator screen comprises a converter layer that comprises a hydrogenous material, exhibits a thickness of from about 10 μm to about 1500 μm, and is formulated to produce recoil protons responsive to interactions with the fast neutrons. A scintillator layer is in contact with the converter layer and comprises a phosphor formulated to produce the photons responsive to interactions with the recoil protons. The photons are configured in a pattern to form a corresponding image of the object. The photons are directed into a detector that is configured to collect the photons. An image of the object is produced from the collected photons.

A system for neutron radiography is also disclosed and comprises a neutron source operably connected to a control panel and a light-tight box comprising a fast neutron scintillator screen. The fast neutron scintillator screen comprises a converter layer that comprises a hydrogenous material, exhibits a thickness of from about 10 μm to about 1500 μm, and is formulated to produce recoil protons responsive to interactions with the neutrons. A scintillator layer is in contact with the converter layer and comprises a phosphor formulated to produce photons responsive to interactions with the recoil protons. A beam collimator is disposed between the light-tight box and the neutron source. A detector is operably connected to the light-tight box, and at least one computer processing unit is operably connected to the detector.

### BRIEF DESCRIPTION OF THE DRAWINGS

While the specification concludes with claims particularly pointing out and distinctly claiming what are regarded as embodiments of the disclosure, various features and advantages of this disclosure may be more readily ascertained from the following description of example embodiments provided with reference to the accompanying drawings, in which:

FIG. 1A is a schematic illustration of a fast neutron scintillator screen in accordance with embodiments of the disclosure;

FIG. 1B is a schematic illustration of a cross-section of the fast neutron scintillator screen of FIG. 1A along the dashed line;

FIG. 2 is a schematic illustration of a system of digital neutron radiography that includes a fast neutron scintillator screen in accordance with embodiments of the disclosure;

FIG. 3 is a flow chart illustrating a method of neutron radiography in accordance with embodiments of the disclosure;

FIG. 4 is a schematic illustration of a fast neutron scintillator screen having varying thicknesses in accordance with embodiments of the disclosure;

FIG. 5 is a graph of light output data of a fast neutron scintillator screen having varying scintillator thickness in accordance with embodiments of the disclosure;

FIG. 6 is a graph of light output data of a fast neutron scintillator screen having varying scintillator thickness in accordance with embodiments of the disclosure;

FIG. 7 is a graph of light output data of a fast neutron scintillator screen having varying converter thickness in accordance with embodiments of the disclosure; and

FIG. 8 is a graph of light output data of a fast neutron scintillator screen having varying converter thickness.

### DETAILED DESCRIPTION

Scintillator screens (e.g., fast neutron scintillator screens) are disclosed, as are systems that include the fast neutron scintillator screens and methods of using the fast neutron scintillator screens. The fast neutron scintillator screen includes two or more layers, such as a converter layer and a scintillator layer. The converter layer and scintillator layer are separate layers (e.g., discrete layers, discrete films) and include an interface between materials of the two layers. The converter layer includes a hydrogenous material, such as a polymeric material. The scintillator layer includes a phosphor formulated to produce photons from interactions of recoil protons with a scintillator material of the scintillator layer following interactions of neutrons with a converter material. The photons are produced responsive to (e.g., in response to) contact between fast neutrons of a neutron beam and the converter material. Each of the separate converter layer and scintillator layer are substantially homogeneous in chemical composition. The fast neutron scintillator screen may be used as a fast neutron detector that provides spatial information, such as detecting a fast neutron field in a two-dimensional space. A proton recoil reaction mechanism is used to mobilize charged particles from the neutrons, which then interact with the scintillator layer to produce photons, which are detected. The separate scintillator layer and the converter layer improve spatial resolution of the fast neutron scintillator screen in comparison to a conventional fast neutron mixed plastic scintillator screen that includes a converter material and a scintillator material mixed together. The conventional fast neutron mixed plastic scintillator screen, therefore, does not include layers or an interface between layers of a scintillator material and a converter material.

The fast neutron scintillator screen may, for example, be used to detect neutrons, such as in neutron radiography or neutron imaging. The fast neutron scintillator screen according to embodiments of the disclosure improves fast neutron imaging performance by enhancing the visualization of features that are small and/or low in contrast. The fast neutron scintillator screen also produces high-resolution images (e.g., high spatial resolution images) by a non-destructive technique and has a high neutron detection efficiency (e.g., a high value of light output). The fast neutron scintillator screen may be used for surveillance, law enforcement, detection, and inspection applications, such as to examine large and/or dense samples including, but not limited to, nuclear fuels, commercial turbines, munitions, or 3D-printed and other advanced-manufactured parts. For example, the fast neutron scintillator screen may be used to determine structural integrity of nuclear fuels after irradiation. The fast neutron scintillator screen may also be used in the surveillance of areas, such as in buildings or vehicles. The fast neutron scintillator screen may also be used to calibrate (e.g., characterize) neutron beams, such as determining the distribution of neutrons in a cross-section of the neutron beam and the uniformity of the distribution.

The following description provides specific details, such as material compositions and processing conditions in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those process components and acts necessary to understand the embodiments of the disclosure are described in detail below. A person of ordinary skill in the art will understand that some process components are inherently disclosed herein and that adding various conventional process components and acts would be in accord with the disclosure. In addition, the drawings accompanying the disclosure are for illustrative purposes only, are not meant to be actual views of any particular scintillator screen, method, or system, and are not necessarily drawn to scale.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the terms “about” and “approximately” in reference to a numerical value for a particular parameter are inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figure. Unless otherwise specified, the spatially relative terms are intended to encompass different orientations of the elements in addition to the orientation depicted in the figure. For example, if elements in the figure are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The elements may be otherwise oriented (e.g., rotated 90 degrees, inverted, flipped) and the spatially relative descriptors used herein interpreted accordingly.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof.

As used herein, the term “converter” and its grammatical equivalents refer to a material that produces ionizing radiation from interactions with neutrons.

As used herein, the term “fast neutron” and its grammatical equivalents refers to a free neutron with a kinetic energy of greater than or equal to about 1 MeV, and thus a speed of about 14,000 km/s or greater.

As used herein, the term “may” with respect to a material, structure, feature or method act indicates that such is contemplated for use in implementation of embodiments of the disclosure and such term is used in preference to the more restrictive term “is” so as to avoid any implication that other, compatible materials, structures, features and methods usable in combination therewith should or must be excluded.

As used herein, the terms “phosphor” and “scintillator phosphor” and their grammatical equivalents refer to a material that produces photons in response to exposure to incident ionizing radiation (e.g., protons, gammas). In some cases, the material may produce photons for an extended period of time.

As used herein, the term “recoil proton” and its grammatical equivalents refer to a proton that is ejected from a material due to elastic scattering caused by interacting the material with a fast neutron.

As used herein, the term “scintillator” and its grammatical equivalents refer to a material that produces optical photons from interactions with (e.g., exposure to) ionizing radiation (e.g., proton radiation).

As used herein, the term “scintillator screen” and its grammatical equivalents refer to a device that includes a scintillator phosphor material or both a converter material and a scintillator phosphor material and that produces photons from interactions with ionizing radiation. The scintillator phosphor material and converter material may be on a substrate that provides mechanical support to the device.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

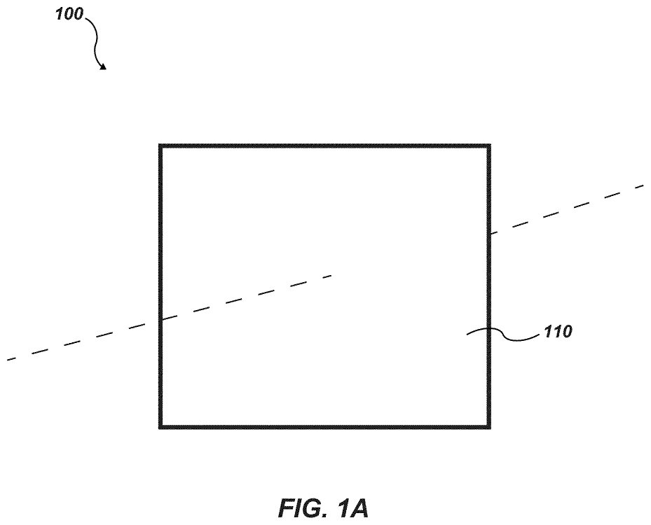

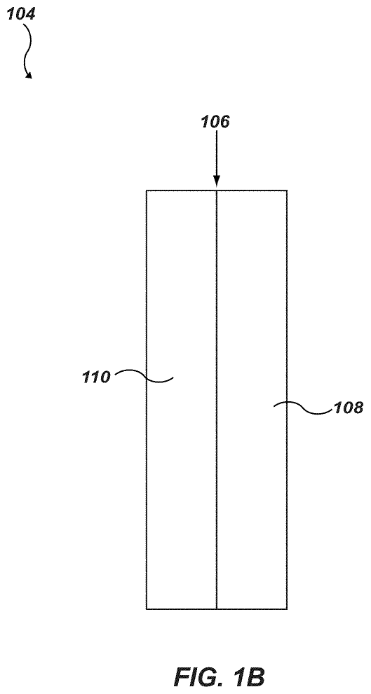

Embodiments of the disclosure are described with reference to FIGS. 1A and 1B, which schematically illustrate a fast neutron scintillator screen 100 according to embodiments of the disclosure. The fast neutron scintillator screen 100 includes a layer of converter material 110 and a layer of scintillator material 108 (e.g., phosphor material, scintillator phosphor material) on a substrate (not shown in FIGS. 1A and 1B). The converter material 110 is positioned on the substrate and the scintillator material 108 is positioned on the converter material 110. The substrate may provide sufficient support to the scintillator material 108 and the converter material 110 for the fast neutron scintillator screen 100. The converter material 110 and the scintillator material 108 are separate (e.g., distinct) from one another and form layers that are coupled together, with an interface 106 (e.g., a common interface) between the converter material 110 and the scintillator material 108. The converter material 110 and the scintillator material 108 may directly contact one another, with the converter material 110 and the scintillator material 108 adhering to one another at the interface 106. The interface 106 (e.g., a common interface) extends substantially the entire length and the entire width of the converter material 110 and the scintillator material 108. Therefore, the interface 106 is defined along (e.g., defined by) surfaces of the converter material 110 and the scintillator material 108. The converter material 110 and the scintillator material 108 may be bonded together or otherwise joined (e.g., attached, adhered). By way of example only, the converter material 110 and the scintillator material 108 may be joined by an adhesive material or a binder material. Adherence between the converter material 110 and the scintillator material 108 may occur by deposition, pressure coupling, the adhesive material, or the binder material. If an adhesive material or a binder material is used, the adhesive material or binder material may be transparent (e.g., optically transparent) so that the photons are not attenuated by the adhesive material or binder material.

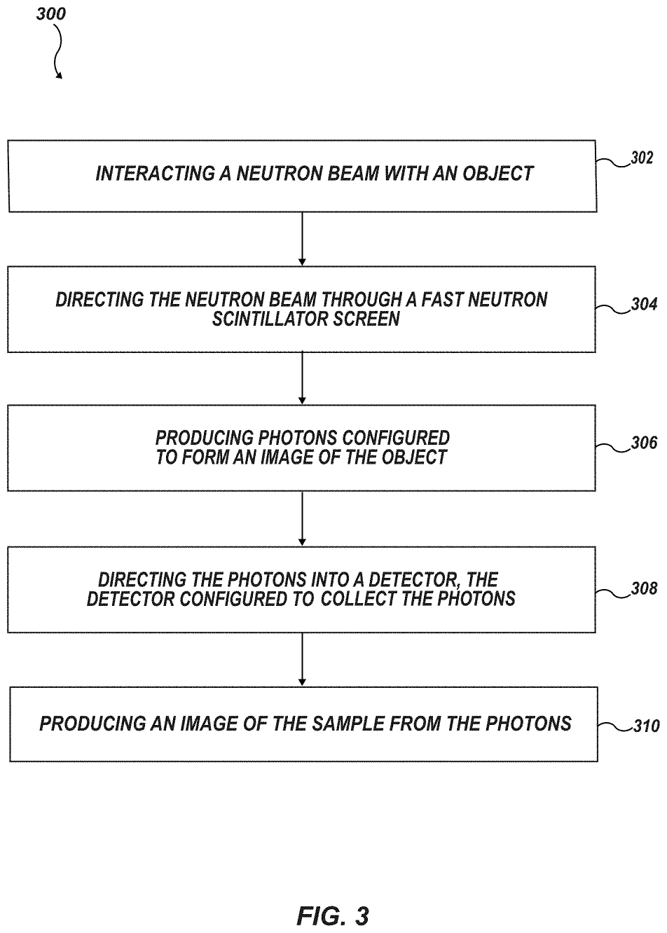

The converter material 110 may be selected to provide structural integrity to the fast neutron scintillator screen 100. By appropriately selecting the stiffness and thickness of the converter material 110, the scintillator material 108 may remain substantially intact on the converter material 110 during use and operation of the fast neutron scintillator screen 100. The converter material 110 may also exhibit a desired degree of reflectivity depending on the intended use of the fast neutron scintillator screen 100. The converter material 110 is also formulated to convert neutrons to charged particles. The reflectivity of the converter material 110 is selected to conserve light generated by the scintillator material 108 during use and operation of the fast neutron scintillator screen 100. The converter material 110 may, for example, be transparent, translucent, opaque, substantially non-reflective, or non-reflective to the light emitted by the scintillator material 108. By conserving the light, a system 200 (see FIG. 3) containing the fast neutron scintillator screen 100 may be used to produce a high-resolution image. The converter material 110 reflects the light generated by the scintillator material 108 to a detector 212 (see FIG. 3) in the system 200. By adjusting the reflectivity of the converter material 110, the resolution of the resulting image produced by the system 200 may be tailored. By way of example only, the reflectivity of the converter material 110 may be increased to increase the resolution of the image.

The converter material 110 may appear white, grey, or black in color depending on the hydrogenous material used and its thickness. If the converter material 110 is white in color (e.g., translucent), photons generated in the scintillator layer 108 during use and operation of the fast neutron scintillator screen 100 and that are directed toward the converter layer 110, may be reflected by the converter material 110 back through the scintillator layer 108 and to the detector 212. If the converter material 110 is grey (e.g., opaque) in color, a smaller proportion of the photons may be reflected by the converter material 110 back through the scintillator layer 108 and to the detector 212. If the converter material 110 is black (e.g., substantially non-reflective, non-reflective) in color, the photons may be least likely to be reflected by the converter material 110 back through the scintillator layer 108 and to the detector 212.

In some embodiments, the converter material 110 is white (e.g., translucent) to enable maximized reflection of the photons back through the scintillator layer to the detector 212. In other embodiments, the converter material 110 is grey to reduce the proportion of reflected photons, in order to achieve a balance between detected light and spatial resolution. In still other embodiments, a darker (e.g., black), more light-absorbing material is used to increase the spatial resolution of the resulting image, but with a possible reduction in detected light. If the converter material 110 is substantially non-reflective or non-reflective (e.g., black), the resulting image generated by the fast neutron scintillator screen 100 may exhibit an increased resolution compared to the image generated if the converter material 110 is white, translucent, or grey.

If the converter material 110 is transparent (e.g., polymethyl methacrylate (PMMA), acrylic, Plexiglas), a backing material (not shown) may be used to maximize or minimize the reflection of light back through the converter layer 110 and scintillator layer 108 to the detector 212. The backing material may be a reflective material, such as a white or mirror-finish material to maximize reflection, or a light-absorbing material, such as a black or other darkly colored material, to minimize reflection.

The converter material 110 may be formed of and include one or more elements with low atomic mass, such as a hydrogenous material. The converter material 110 may include a hydrogenous polymer material, such as an organic, hydrogenous polymer material having a high hydrogen content. Performance of the converter material 110 may be directly proportional to the hydrogen content (e.g., number of hydrogen atoms per unit volume) of the converter material 110. The converter material 110 may include, but is not limited to, polyethylene (PE), high-density polyethylene (HDPE), polypropylene (PP), an alkylbenzene, such as polyvinyltoluene (PVT), a similar polymeric material including carbon and hydrogen, or a combination thereof. In some embodiments, the converter material 110 is HDPE, which has a higher number of hydrogen atoms per unit volume than other hydrogenous polymers. However, other high hydrogen content, organic polymeric materials may be used as the converter material 110. The layer of converter material 110 may include a single material and exhibit a homogeneous (e.g., uniform) chemical composition across its thickness.

A thickness of the converter material 110 may be sufficient to provide mechanical strength and the desired reflectivity to the fast neutron scintillator screen 100. The thickness of the converter material 110 may be proportional to the light output of the scintillator material 108. The thickness of the converter material 110 may be in the range of a recoil proton or a multiple of the range of a recoil proton. A recoil proton interaction occurs when a fast neutron scatters with a hydrogen atom in the converter material 110, ejecting a proton, which is referred to as a recoil proton. The recoil proton may further interact with converter material atoms to produce additional recoil protons. The converter material 110 thickness may be similar to (e.g., matched to) the range of the recoil protons (from about 300 μm to about 500 μm). The converter material 110 may, for example, have a thickness in a range of from about 10 μm to about 5 mm (5000 μm), such as from about 50 μm to about 3 mm, from about 50 μm to about 1000 μm, from about 100 μm to about 3000 μm, from about 100 μm to about 1000 μm, from about 100 μm to about 500 μm, from about 100 μm to about 800 μm, from about 200 μm to about 600 μm, from about 300 μm to about 500 μm, from about 300 μm to about 800 μm, or from about 300 μm to about 600 μm. In contrast, conventional fast neutron mixed plastic scintillator screens have a substantially greater thickness of from about 1500 μm to about 3000 μm. The conventional fast neutron mixed plastic scintillator screens, therefore, do not include layers or an interface between layers of the scintillator material and the converter material. The converter material 110 according to embodiments of the disclosure may exhibit a uniform thickness along its length and width. By utilizing the converter material 110 at a thickness of from about 100 μm to about 800 μm, the scintillator material 108 interactions and light output are maximized, while neutron scatter and light diffusion are minimized. By increasing the thickness of the converter material 110, the probability of a fast neutron scattering interaction occurring increases. However, the increased thickness of the converter material 110 may result in decreased image resolution. Therefore, scintillator material 108 light output and image resolution of the fast neutron scintillator screen 100 may be tailored by selecting the thickness of the converter material 110.

The scintillator material 108 includes a scintillator phosphor material that is formulated to interact with recoil protons produced in the converter layer 110 by the interaction of neutrons from the neutron source with the converter material. The scintillator material 108 produces scintillation, a luminescence property, when excited by ionizing radiation. When an incoming ionizing particle (e.g., proton, gamma) strikes the phosphor material, the scintillator material 108 absorbs some or all of its energy and re-emits it in the form of light. The scintillator phosphor material produces photons from interactions with the ionizing particles. The scintillator material 108 may include a material having a low atomic number and a low sensitivity to gamma radiation. The scintillator material 108 may be substantially transparent to neutrons such that neutrons do not substantially interact with the scintillator material 108. The scintillator material 108 may also be selected based on a desired peak wavelength of light output to be generated by the scintillator material 108 and detected by the detector 212 of the system 200, which is determined by the intended use of the fast neutron scintillator screen 100.

The scintillator material 108 may include, but is not limited to, an activated zinc sulfide (ZnS) material, an activated gadolinium oxysulfide (Gd₂O₂S, GOS) material, an activated yttrium oxysulfide (Y₂O₂S, YOS) material, a cesium iodide (CsI) material, or a combination thereof. However, other phosphor materials may be used. Activator species of the phosphor of the scintillator material 108 may be present at a desired concentration and may be selected depending on the desired wavelength of light output. By way of example only, the scintillator material 108 may be copper-activated zinc sulfide (e.g., ZnS:Cu), silver-activated zinc sulfide (ZnS:Ag), praseodymium-activated gadolinium oxysulfide (GOS:Pr), terbium-activated gadolinium oxysulfide (GOS:Tb), europium-activated gadolinium oxysulfide (GOS:Eu), terbium-activated yttrium oxysulfide (YOS:Tb), thallium-activated CsI (CsI:Tl), or a combination thereof. In some embodiments, the scintillator material 108 is ZnS:Ag or ZnS:Cu. In other embodiments, the scintillator material 108 is GOS:Pr, GOS:Tb, GOS:Eu, or YOS:Tb. The layer of scintillator material 108 may include a single material and exhibit a homogeneous (e.g., uniform) chemical composition across its thickness. The scintillator material 108 may be a solid, such as a powder. The scintillator material 108 may exhibit a particle size of from about 0.1 μm to about 100 μm depending on the intended use for the fast neutron scintillator screen 100.

The scintillator material 108 may exhibit a minimal thickness to achieve the desired high-resolution images. The scintillator material 108 may exhibit a uniform thickness along its length and width. The scintillator material 108 may, for example, have a thickness in a range of from about 10 μm to about 500 μm, such as from about 50 μm to about 400 μm, from about 100 μm to about 300 μm, from about 100 μm to about 400 μm, from about 100 μm to about 500 μm, from about 200 μm to about 400 μm, from about 200 μm to about 500 μm, from about 300 μm to about 500 μm, from about 50 μm to about 500 μm, from about 50 μm to about 300 μm, or from about 50 μm to about 200 μm.

To form the fast neutron scintillator screen 104 according to embodiments of the disclosure, the scintillator material 108 may be formed (e.g., deposited) on the converter material 110 or attached (e.g., adhered) to the converter material 110. Alternatively, the converter material 110 may be formed (e.g., deposited) on the scintillator material 108 or attached (e.g., adhered) to the scintillator material 108. The scintillator material 108 may, for example, be dissolved or suspended in an organic solvent and/or a binder that adheres to a surface of the converter material 110. The solution or suspension of the scintillator material 108 may subsequently be cured (e.g., heated, dried) to a dry state, forming the scintillator material 108 on the converter material 110 as a layer or film. Therefore, the volume of organic solvent or binder may minimally contribute to the thickness of the scintillator material 108. Additives may optionally be added to the solution or suspension to adjust the cure rate. The organic solvent or binder may secure the scintillator material 108 to the converter material 110. The organic solvent or binder may be optically transparent to minimize light attenuation.

While FIGS. 1A and 1B illustrate the scintillator material 108 as being a single material, two or more scintillator materials 108 may be used to discriminate between different energies and types of ionizing radiation in the same flux. For example, the fast neutron scintillator screen 104 may include separate layers of scintillator material 108 and converter material 110, but with a different converter material mixed with the scintillator material 108, and/or a different scintillator material mixed with the converter material 110. Alternatively, several layers of scintillator material 108 may be used, with one or more of the phosphors in each layer being different. The layers may have a common interface and may be coupled in any of the ways described above. In such an embodiment, the discrimination of different neutron ranges, gamma rays, alpha rays, and other particles may be possible because the different scintillator materials 108 may convert ionizing radiation into photons having different wavelengths and the decay characteristics (e.g., timing and curve shape) of the light output of the different scintillator materials 108 may vary, which may be determined by specialized electronics.

Without being bound by any theory, it is believed that the fast neutron scintillator screen 100 according to embodiments of the disclosure provides increased spatial resolution due to its decreased thickness compared to conventional fast neutron mixed plastic scintillator screens. The spatial resolution may range from about 10 μm to about 1000 μm. The thinner, fast neutron scintillator screen 100 provides less attenuation and scattering of the photons that are produced during use and operation of the fast neutron scintillator screen 100 than conventional fast neutron mixed plastic scintillator screens. Therefore, the fast neutron scintillator screen 100 having the discrete scintillator and converter materials 108, 110 may be used to produce high-resolution fast neutron images. In contrast, scattered photons create a blurred image as they are dispersed from the interaction location during use and operation of conventional fast neutron mixed plastic scintillator screens and systems and conventional film-based systems. Light output of the fast neutron scintillator screen 100 was also found to increase up to and beyond the range of a recoil proton. It was expected that the light output would increase up to the range of the recoil proton but would not substantially increase beyond the range of the recoil proton. However, the light output of the fast neutron scintillator screen 100 was unexpectedly found to increase substantially linearly when the converter material 110 exhibited a thickness of up to about 3000 μm. Without being bound by any theory, it is believed that primary recoil protons create subsequent recoil protons.

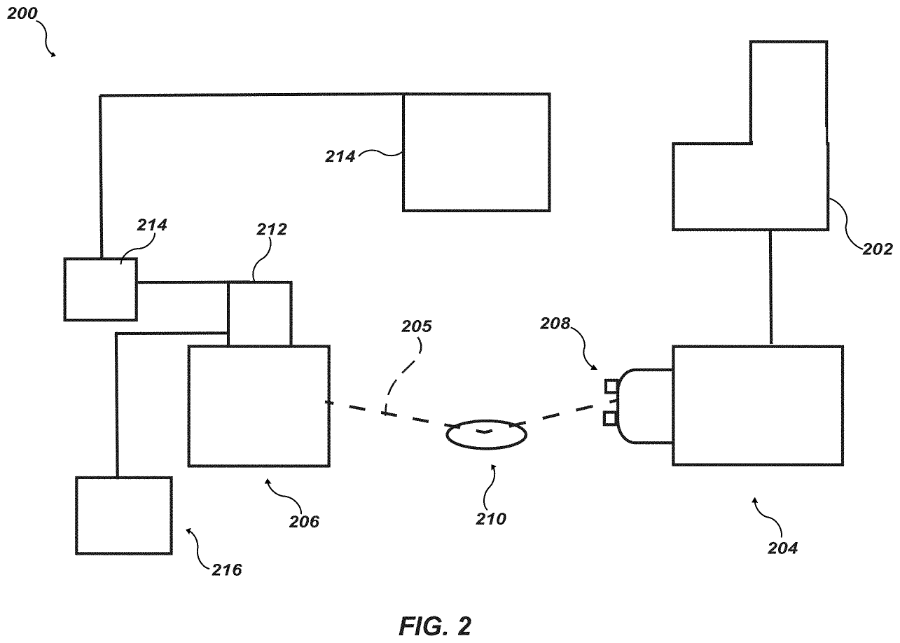

Referring now to FIG. 2, a system 200 of digital neutron radiography utilizing a fast neutron scintillator screen 100 according to embodiments of the disclosure is schematically illustrated. The system 200 includes a control panel 202 that is operably connected to a neutron source 204. The neutron source 204 may include, but is not limited to, a neutron generator, a particle accelerator, a spallation neutron source, and a nuclear reactor beamline with a direct line of sight to the core. The neutron source 204 is configured to emit a neutron beam 205 in the direction of a sample 210. The system further includes a light-tight box 206 comprising the fast neutron scintillator screen 100 as described above. The light-tight box 206 may optionally include at least one mirror. A beam collimator 208 may be disposed between the light-tight box 206 and the neutron source 204. The beam collimator 208 may be configured to eliminate neutrons that have trajectories that are not inside the space defined by the light-tight box 206, to reduce noise read by a detector 212, and to reduce neutron activation of the sample 210. The sample 210 that is the subject of imaging may be disposed between the light-tight box 206 and the neutron source 204. The detector 212 (e.g., an electron-multiplying charge-coupled device, a charged coupled device (CCD)) may be operably connected to the light-tight box 206, and at least one computer processing unit 214 may be operably connected to the detector 212. A water cooler 216 may optionally be operably connected to the detector 212. The components (control panel 202, neutron source 204, light-tight box 206, beam collimator 208, detector 212, computer processing unit 214, water cooler 216) of the system 200 may be selected and configured as known in the art.

Still referring to FIG. 2, the detector 212 (e.g., a CCD camera) may be used to capture the photon production from the fast neutron scintillator screen 100 inside of the light-tight box 206. Neutrons are uncharged particles and are present in the nucleus of an atom along with protons. The chargeless (e.g., uncharged) nature of the neutrons prevents electromagnetic interactions and the neutrons primarily interact with matter through either scattering collisions or absorption reactions, which occur within the nucleus of the atom. When the system 200 is in operation, fast neutrons interact with the converter material 110 of the fast neutron scintillator screen 100 through an elastic scattering mechanism with the nuclei of the atoms of the converter material 110. This collision transfers the neutrons' kinetic energy to protons, which are ejected from the nuclei. The protons, through their electric charges, undergo electromagnetic interactions with the scintillator material 108 and produce photons, which are collected by the detector 212 and used to produce the image.

The light-tight box 206 may be constructed from anodized aluminum to minimize the delayed activation gamma photons produced under neutron irradiation. The light-tight box 206 may also be used to shield the detector 212 from ambient light. Flat-black paint may be used inside the light-tight box 206 to prevent photon reflection inside the box, which may distort the resultant image. Additionally, a black duvetyne (i.e., high opacity twill fabric with a velvet-like nap on one side) cloth may be placed over the light-tight box 206 to ensure additional shielding from ambient light. The fast neutron scintillator screen 100 may be mounted inside the light-tight box 206, and a front-surface mirror mounted (not shown) at a 45° angle may be used to reflect the image into a lens of the detector 212. The detector 212 may be accessed remotely from the computer processing unit 214 and the pattern of collected photons analyzed and rendered to form the image of the sample 210. By using the digital neutron radiography system 200, high-resolution images may be acquired quicker than conventional film-based systems, improving the efficiency of neutron detection.

Embodiments of the disclosure will now be described with reference to FIG. 3, which is a flow chart illustration of a method 300 of neutron radiography to image an object (e.g., sample 210). As shown in act 302, the method 300 may include interacting a neutron beam (e.g., neutron beam 205) with the object. The object may be the subject of the neutron radiography. The neutron beam may be directed from a neutron source (e.g., neutron source 204) towards the object and towards a detector (e.g., detector 212) of a system (e.g., system 200) used to detect photons generated by the neutrons from the neutron beam, as shown in act 304. The object is exposed to the neutrons of the neutron beam, with some neutrons absorbed by the object and other neutrons passing around the object and towards a converter layer including a converter material of a fast neutron scintillator screen (e.g., fast neutron scintillator screen 100). After interacting with the object, the neutrons are directed through the converter layer and a scintillator layer including a scintillator material of the fast neutron scintillator screen, producing charged particles and photons, respectively, configured to form a corresponding image of the object, as shown in act 306. The fast neutrons interact with the object and reach the converter layer in a pattern corresponding to that of the object. In other words, some neutrons from the neutron beam may miss the object while other neutrons are attenuated by absorption or scattering with the object. The neutrons that reach the converter layer are converted to charged particles, which are converted to photons by the scintillator layer. The fast neutron scintillator screen may include the fast neutron scintillator screen 100 described above. The photons are directed into the detector, where the detector collects (e.g., senses) the photons, as shown in act 308. The detector measures the photons generated from the neutrons that are not absorbed by the object. The photons may be read by the detector, producing a corresponding image of the object from the photons, as shown in act 310. The detector may include a charge-coupled device, such as the detector 212 (e.g., a CCD camera). However, various detectors may be used, for example, depending on the peak wavelength of light emitted by the scintillator material 108.

The fast neutron scintillator screens 100, systems 200, and methods of utilizing them in accordance with the disclosure are advantageous over conventional fast neutron mixed plastic scintillator screens, systems, and methods because the fast neutron scintillator screens 100 are able to produce high-resolution neutron images. By including the converter material 110 and the scintillator material 108 as discrete, separate layers, rather than being mixed together as with conventional fast neutron mixed plastic scintillator screen, the ability of visualizing features that are small and/or low in contrast is substantially increased. Additionally, the fast neutron scintillator screens 100 exhibit a thickness that maximizes the number of recoil protons reaching the scintillator material 108. For example, the converter material 110 thickness may be similar to (e.g., matched to) the range of the recoil protons (from about 300 μm to about 500 μm), while the conventional fast neutron mixed plastic scintillator screens have thickness of from about 1500 μm to about 3000 μm. Furthermore, recent advances in accelerator-based fast neutron sources are producing brighter neutron sources, which may be installed at industrial sites. Therefore, use of the fast neutron scintillator screens 100 and systems 200 may be expanded, making fast neutron imaging a more viable examination tool for industry and research centers worldwide. The spatial resolution of fast neutron images may be significantly improved, enabling high quality, fast neutron radiography and tomography of large or dense samples to be conducted.

The following examples serve to further illustrate embodiments of the disclosure in more detail. These examples are not to be construed as being exhaustive or exclusive as to the scope of this disclosure.

### EXAMPLES

### Example 1

Samples of fast neutron scintillator screens were formed using the scintillator (phosphor) and converter materials listed in Table 1.

TABLE 1
Formulations of Phosphors and Converter Materials in Fast Neutron Scintillator Screens

| | Median | | | | | | | Scintillator |
|---|---|---|---|---|---|---|---|---|
| | Particle | | | | Converter | | Backing | Size |
| Phosphor | Size | | Phosphor Thicknesses | Converter | Thicknesses | Topcoat | (Substrate) | (cm × cm) |
| GOS:Pr | 20 | μm | 5 strips, each 2 cm × 10 cm of | HDPE | Wedged, | Protective | A12 black satin | 10 cm × 12 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| GOS:Pr | 20 | μm | 5 strips, each 2 cm × 10 cm of | HDPE | Wedged, | Protective | A12 black satin | 10 cm × 12 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| GOS:Pr | 3.5 | μm | 5 strips, each 2 cm × 10 cm of | HDPE | Wedged, | Protective | A12 black satin | 10 cm × 12 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| GOS:Pr | 3.5 | μm | 5 strips, each 2 cm × 10 cm of | HDPE | Wedged, | Protective | A12 black satin | 10 cm × 12 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| GOS:Pr | 6 | μm | 5 strips, each 2 cm × 10 cm of | HDPE | Wedged, | Protective | A12 black satin | 10 cm × 12 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| GOS:Pr | 6 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| YOS:Tb | 7-8 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| YOS:Tb | 7-8 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| YOS:Tb | 1.5-2 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| YOS:Tb | 1.5-2 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| ZnS:Ag | 8-10 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| ZnS:Ag | 8-10 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| ZnS:Cu | 11.5 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| ZnS:Cu | 11.5 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| ZnS:Cu | 8.1 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| ZnS:Cu | 8.1 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| ZnS:Cu | 6.7 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| ZnS:Cu | 6.7 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| ZnS:Cu | 4.7 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | conductive |
| | | | 200 μm, 100 μm and 50 μm | | −0.010″ | | (11 cm × 13 cm) | material |
| ZnS:Cu | 4.7 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| GOS:Tb | 10 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |
| GOS:Tb | 10 | μm | 5 strips, each 2 cm × 10 cm of | HDPE | Wedged, | Protective | A12 black satin | 10 cm × 10 cm |
| | | | thicknesses ~400 μm, 300 μm, | | ~3 mm | | aluminum | |
| | | | 200 μm, 100 μm and 50 μm | | −0.010″ | | (11 cm × 13 cm) | |

### Example 2

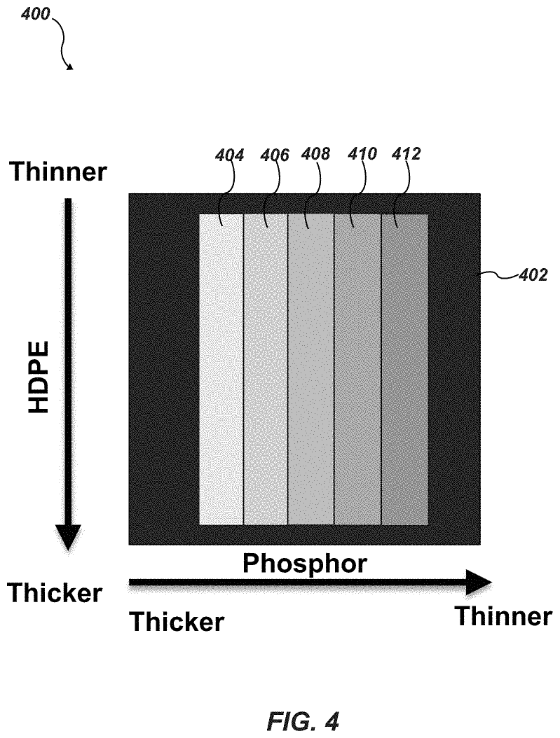

Example embodiments of fast neutron scintillator screens 400 were tested and are schematically illustrated in FIG. 4. The fast neutron scintillator screens 400 included converter and scintillator materials that were separately disposed on a substrate 402. The substrate 402 was comprised of aluminum. The scintillator material was comprised of ZnS:Cu and was deposited on HDPE as the converter material.

The fast neutron scintillator screens 400 were tested at Heinz Maier-Leibnitz Zentrum (FRM II), Technical University of Munich, research neutron source. A wedge of HDPE, ranging continuously in thickness from about 50 μm to about 3 mm along the vertical direction, was used as the converter material. Scintillator material (including ZnS:Cu) was deposited in strips of discrete thicknesses, varying in the horizontal direction. Strip 404 had a thickness of about 400 μm, strip 406 had a thickness of about 300 μm, strip 408 had a thickness of about 200 μm, strip 410 had a thickness of about 100 μm, and strip 412 had a thickness of about 50 μm. The HDPE was attached to an aluminum substrate for structural support, with the scintillator material deposited on the HDPE.

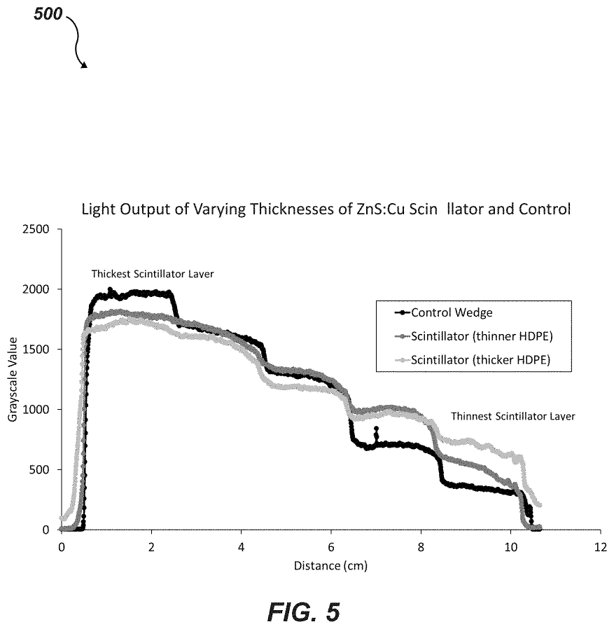

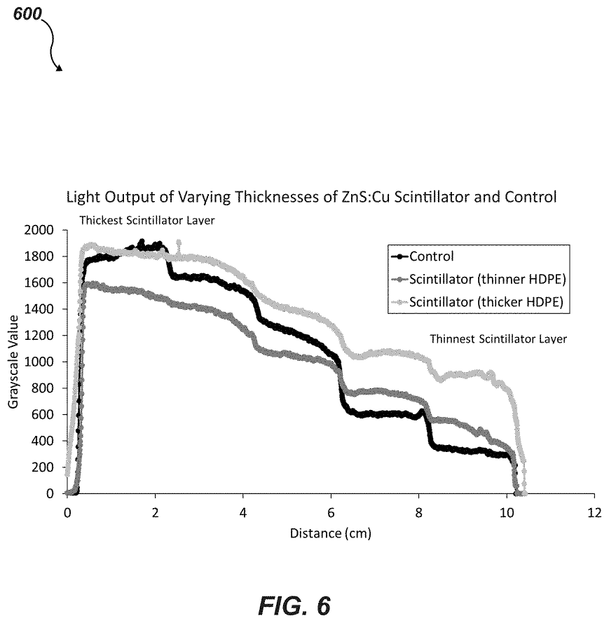

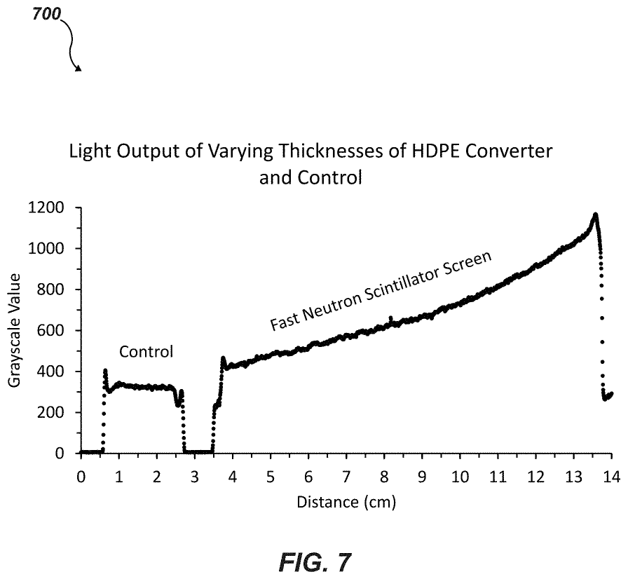

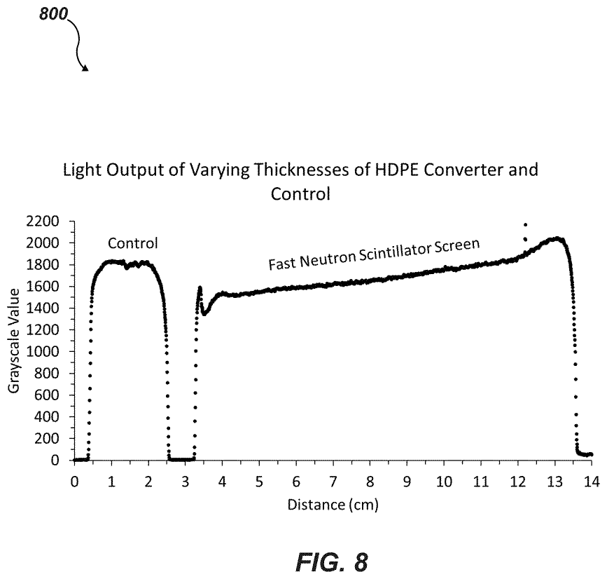

The goal of the layered method of scintillator screen fabrication was to provide a compact combinatorial study in which combinations of converter and scintillator material thicknesses could be tested to see which produced the best light output for fast neutron imaging. The neutron radiograph generated a two-dimensional light output profile (analyzed in FIGS. 5-8), which was used to measure the light output for each combination of converter material and scintillator material thicknesses. The method was also used to measure the fast neutron scintillator screens for improved spatial resolution.

To distinguish between scintillation photons resulting from fast neutrons and those created by gamma rays, a control plate that included the scintillator material of the same thicknesses adhered directly to the aluminum substrate without the converter material was used. The control plate's lack of converter material caused scintillation photons to be produced by gamma rays as opposed to neutrons. Subtracting the grayscale value of the control plate (gamma ray signal) from the grayscale value measured in the scintillator screen (fast neutron and gamma-ray signal) yielded the fast neutron signal.

Referring now to FIGS. 5-8, the light outputs of the control and fast neutron scintillator screens 400 are shown. FIGS. 5-8 show grayscale values as a function of distance. The graphs 500, 600, 700, and 800 illustrate that the fast neutron scintillator screens 400 produced a greater light output for certain thicknesses than the control. At thinner scintillator thicknesses, the fast neutron signal was stronger than the control because the addition of the HDPE converter material caused a proton recoil effect, which produced more photons. Without being bound by any theory, it is believed that the thicker HDPE attenuated more gamma-rays than it produced proton recoils. This may have caused fewer particles to reach the scintillator material, resulting in a lower light output. It is believed that as the HDPE thickness increased, the light output also increased because either more proton recoils occurred or more neutrons were scattered, producing additional proton recoil interactions. In addition, the noise from gamma rays was less.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalents. For example, elements and features disclosed in relation to one embodiment may be combined with elements and features disclosed in relation to other embodiments of the disclosure.

What is claimed is:

1. A fast neutron scintillator screen, comprising:
a converter layer comprising a hydrogenous material and exhibiting a thickness of from about 10 μm to about 1500 μm, the converter layer formulated to produce recoil protons responsive to interactions with neutrons; and
a scintillator layer in contact with the converter layer, the scintillator layer comprising a phosphor formulated to produce photons responsive to interactions with the recoil protons.

2. The fast neutron scintillator screen of claim 1, wherein an interface is present between the converter layer and the scintillator layer.

3. The fast neutron scintillator screen of claim 2, wherein the interface extends substantially an entire length and an entire width of the converter layer and the scintillator layer.

4. The fast neutron scintillator screen of claim 1, wherein the hydrogenous material comprises a hydrogenous polymer material.

5. The fast neutron scintillator screen of claim 1, wherein the hydrogenous material is transparent, translucent, or opaque to a wavelength range of light generated by the scintillator layer.

6. The fast neutron scintillator screen of claim 1, wherein the hydrogenous material is non-reflective, substantially non-reflective, substantially reflective, or reflective to a wavelength range of light generated by the scintillator layer.

7. The fast neutron scintillator screen of claim 1, wherein the hydrogenous material comprises polyethylene or high-density polyethylene.

8. The fast neutron scintillator screen of claim 1, wherein the scintillator layer comprises an activated zinc sulfide material, an activated gadolinium oxysulfide material, an activated yttrium oxysulfide material, a cesium iodide material, or a combination thereof.

9. The fast neutron scintillator screen of claim 1, wherein the scintillator layer comprises copper-activated zinc sulfide, silver-activated zinc sulfide, praseodymium-activated gadolinium oxysulfide, terbium-activated yttrium oxysulfide, europium-activated gadolinium oxysulfide, terbium-activated yttrium oxysulfide, thallium-activated cesium iodide, or a combination thereof.

10. The fast neutron scintillator screen of claim 1, wherein the converter layer exhibits a thickness of from about 100 μm to about 1500 μm.

11. The fast neutron scintillator screen of claim 1, wherein the converter layer exhibits a thickness of from about 300 μm to about 500 μm.

12. The fast neutron scintillator screen of claim 1, wherein the scintillator layer exhibits a thickness between about 10 μm and about 500 μm.

13. The fast neutron scintillator screen of claim 1, wherein the scintillator layer exhibits a thickness between about 100 μm and about 500 μm.

14. The fast neutron scintillator screen of claim 1, further comprising a substrate in contact with the converter layer.

15. A method of conducting neutron radiography, comprising:
interacting a neutron beam with an object;
directing fast neutrons from the neutron beam through a fast neutron scintillator screen to produce photons, the photons configured in a pattern to form a corresponding image of the object, the fast neutron scintillator screen comprising:
a converter layer comprising a hydrogenous material and exhibiting a thickness of from about 10 μm to about 1500 μm, the converter layer formulated to produce recoil protons responsive to interactions with the fast neutrons; and
a scintillator layer in contact with the converter layer, the scintillator layer comprising a phosphor formulated to produce the photons responsive to interactions with the recoil protons;
directing the photons into a detector, the detector configured to collect the photons; and
producing an image of the object from the collected photons.

16. The method of claim 15, wherein directing fast neutrons from the neutron beam through a fast neutron scintillator screen comprises directing the fast neutrons through the fast neutron scintillator screen comprising the converter layer exhibiting a thickness of from about 300 μm to about 500 μm.

17. The method of claim 15, wherein producing an image of the object from the collected photons comprises producing the image at a spatial resolution of from about 10 μm to about 3000 μm.

18. A system for neutron radiography, comprising:
a neutron source operably connected to a control panel;
a light-tight box comprising a fast neutron scintillator screen, the fast neutron scintillator screen comprising:
a converter layer comprising a hydrogenous material and exhibiting a thickness of from about 10 μm to about 1500 μm, the converter layer formulated to produce recoil protons responsive to interactions with neutrons from the neutron source; and
a scintillator layer in contact with the converter layer, the scintillator layer comprising a phosphor formulated to produce photons responsive to interactions with the recoil protons;
a beam collimator disposed between the light-tight box and the neutron source;
a detector operably connected to the light-tight box; and
at least one computer processing unit operably connected to the detector.

19. The system of claim 18, wherein the neutron source comprises a neutron generator, a particle accelerator, a spallation neutron source, or a nuclear reactor beamline.
